(19) United States
(12) Patent Application Publication
(10) Pub. No.: US 2018/0166891 A1
(43) Pub. Date: Jun. 14, 2018

(54) CHARGING SYSTEM

(71) Applicant: Shenzhen Hello Tech Energy CO., LTD., Shenzhen (CN)

(72) Inventors: Meichan WEN, Shenzhen (CN); Yongli ZHOU, Shenzhen (CN); Xuhe LIU, Shenzhen (CN)

(73) Assignee: Shenzhen Hello Tech Energy CO., LTD., Shenzhen (CN)

(21) Appl. No.: 15/893,679

(22) Filed: Feb. 11, 2018

Related U.S. Application Data
(63) Continuation-in-part of application No. PCT/CN2015/093848, filed on Nov. 5, 2015.

(30) Foreign Application Priority Data
Aug. 20, 2015 (CN) 201510514645.1

(51) Int. Cl. H02J 7/00; G06F 21/31; G06Q 20/18

(52) U.S. Cl. CPC H02J 7/0021; G06Q 20/18; G06F 21/31; H02J 7/0044

(57) ABSTRACT

A charging system includes a plurality of mobile power supplies, a plurality of charging units, and a control device. The charging unit includes a fixing device and a charging device, the fixing device being changeable between a locked state where one of the mobile power supplies can be locked in the charging unit by the fixing device and an unlocked state where the one of the mobile power supplies is unlocked from the charging unit. The charging device is configured to charge the mobile power supply fixed in the charging unit. The control device is connected to the charging units, the control device is configured to receive a charging request from a user and generate an unlock command in response to the charging request to control at least one of the fixing devices to switch to the unlocked state.

### CROSS REFERENCE TO RELATED APPLICATIONS

This non-provisional patent application is a Continuation In Part application of International Application PCT/CN2015/093848, filed on Nov. 5, 2015, which claims priority from Chinese Patent Application No. 201510514645.1 filed Aug. 20, 2015. These two applications are incorporated herein by reference.

### TECHNICAL FIELD

The present invention relates generally to charging technology, and, more particularly, to a charging system with mobile power supplies.

### BACKGROUND OF THE INVENTION

With the increasing development of the modern technology, the electronic devices such as mobile phones, tablet PCs and so on have gradually become essential to people's life. However, the bottleneck of battery technology makes the battery life of these devices not capable of meeting the needs of long-time use. To solve the contradiction, charging stations are provided for users in some public places such as stations, restaurants and cinema etc. However, due to large flow of people in public places, a limited number of charging stations can't meet the actual needs, and users need to get to designated location to charge the devices and need to look after the electronic devices in the charging process, so as to avoid the loss of them. This kind of charging system is inconvenient and unsafe.

### SUMMARY OF THE INVENTION

It is necessary to provide a charging system that enhances the convenience and security of the user's charging request.

A charging system, comprising a plurality of mobile power supplies, a plurality of charging units and a control device. The charging unit includes a fixing device and a charging device, the fixing device being changeable between a locked state where one of the mobile power supplies can be locked in the charging unit by the fixing device and an unlocked state where said one of the mobile power supplies is unlocked from the charging unit, the charging device being configured to charge said one of the mobile power supplies fixed in the charging unit. The control device is connected to the charging units, the control device is configured to receive a charging request from a user and generate an unlock command in response to the charging request to control at least one of the fixing devices to switch to the unlocked state so that the user can take the mobile power supply away from the charging unit.

Preferably, the charging request includes the user's information. The control device is further configured to determine whether the user has an operation permission according to the user's information and generate the unlock command when the user has an operation permission.

Preferably, the user's information includes state of use. The state of use includes both in-use and unused states. The control device is further configured to record the information of the mobile power supply and the user's information to generate a usage record, and switching the use state to the in-use state after it is detected that the mobile power supply is removed from the charging unit. The control device is further configured to obtain the user's information from the usage record according to the information of the mobile power supply and switching the use state to an unused state after it is detected that a mobile power supply is put into the charging unit.

Preferably, the user's information further includes information of the payment account, and the control device is further configured to deduct from the payment account when the use status in the user's information is switched from the in-use status to the unused status.

Preferably, the system further comprises a charging seat, the plurality of mobile power supplies, the plurality of charging units and the control device being disposed on the charging seat; and the charging seat further includes an input device configured for the user to input the unlock command.

Preferably, the input device is a keyboard or a touch screen for inputting a password, or a device for code scanning for scanning bar codes and two-dimensional codes.

Preferably, the charging device includes a circuit for charging and a circuit for output. The circuit for charging is disposed inside the charging seat. The circuit for output is configured to perform a wired or wireless connection with a mobile power supply fixed on the charging unit. The control device is further configured to monitor the power of the mobile power supply fixed on the charging unit in real time and control the charging process according to the power.

Preferably, the control device is further configured to output the unlocked command to all the fixing devices with the mobile power supplies. The control device is further configured to control the fixing device fixed with a mobile power supply to switch to the locked state after it is detected that the mobile power supply is removed from the charging unit.

Preferably, the charging request further includes a data of power amount, the control device is further configured to generate an unlock command after matching the target mobile power supply according to the power data, and the unlock command is used to unlock a fixing device where the target mobile power supply is located.

Preferably, the system further comprises a module for indication alarm, and the control device is further configured to generate an alarm signal when it is monitored that the fixing device is in a locked state but the mobile power supply is removed. The module for indication alarm is configured to send an alarm according to the alarm signal. The module for indication alarm is further configured to instruct the fixing device in the unlocked state.

Preferably, the system further comprises a server, the server is connected to the control device and the server is configured to monitor the power status and the running status of the mobile power supply in real time.

Preferably, the fixing device comprises a magnetic device disposed inside the charge seat. A metal structure corresponding to the magnetic device is arranged on the mobile power supply.

Preferably, the charging device comprises a magnetic output terminal, and the movable power supply is provided with a metal contact adapted to the magnetic output terminal.

Preferably, the charging device comprises a USB output interface. A USB interface adapted to the USB output interface is provided on the mobile power supply.

Preferably, the charging method using the charging system comprises: the control device receiving a charging request form an user and sending an unlock command in response to the charging request to a corresponding charging unit; the fixing device of the charging unit switching to the unlock state to release the corresponding mobile power supply; and removing the corresponding mobile power supply from the charging unit and using the mobile power supply to charge an electric device.

Preferably, the method further comprises: returning the mobile power supply back to the charging unit and the control device controlling the fixing device of the charging unit to fix the mobile power supply and the charging device of the charging unit to charge the mobile power supply.

Preferably, the charging request includes the user's information and the method further comprises: the control device judging whether the user has an operation permission according to the user's information and generating the unlock command when the user has an operation permission.

Preferably, the user's information comprises state of use which includes an in-use state and an unused state, and the method further comprises: the control device recording the information of the mobile power supply and the user's information to generate a usage record, and switching the state of use to the in-use state when it is detected that the mobile power supply is removed from the charging unit.

Preferably, the method further comprises: the control device obtaining the user's information from the usage record according to the information of the mobile power supply and switching the use state to the unused state when it is detected that a mobile power supply is put into the charging unit.

Preferably, the method further comprises: the control device sending the unlocked command to all fixing devices fixed with the mobile power supplies, and the control device controlling the fixing devices fixed with mobile power supplies to switch to the locked state after it is detected that one of the mobile power supplies is removed from the corresponding charging unit.

In the above charging system, a plurality of mobile power sources are provided. Therefore, the mobile power supply can be provided to the user according to the charging request of the user to meet the charging request of the user, without requiring the user to place the electronic device such as the mobile phone at a designated location for charging, thereby improving convenience and safety of charging process.

### BRIEF DESCRIPTION OF THE DRAWINGS

FIG. 1 illustrates a diagram of a charging system in accordance with an embodiment of the present invention.

FIG. 2 illustrates a diagram of a charging system in accordance with an alternative embodiment of the present invention.

FIG. 3 illustrates a diagram of a charging seat of the charging system of FIG. 2.

FIG. 4 illustrates a flow chart of the charging method.

### DETAILED DESCRIPTION OF THE INVENTION

In the following, the invention is further described with reference to the drawings and specific embodiments. It should be noted that, without conflict, any combination of the embodiments or the features may form a new embodiment.

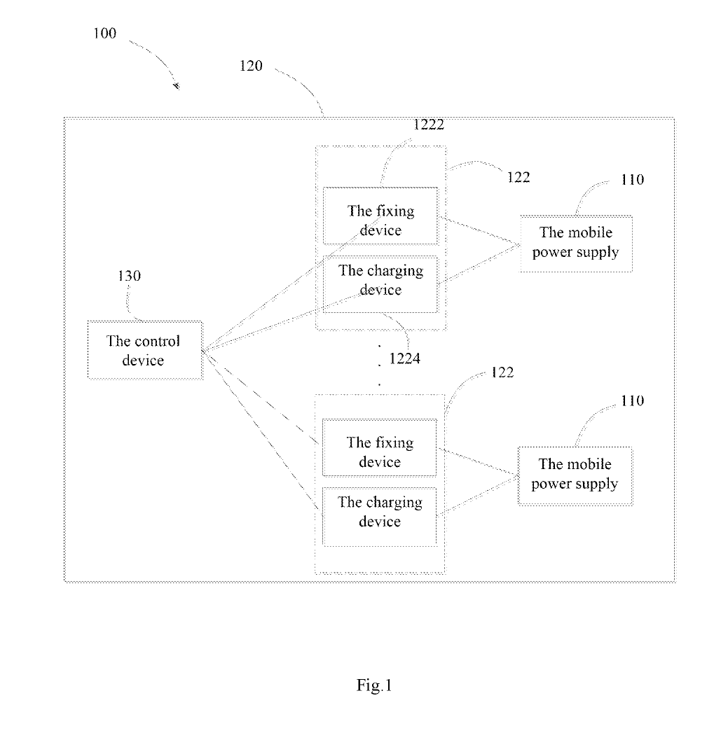

A charging system is configured to provide mobile power supply for users to charge their portable digital devices according to their requests. The charging systems can be used at stations, restaurants, cinemas, shopping centers and other public places with large flow of people. FIG. 1 is a structural block diagram of a charging system 100 in accordance with an embodiment of the present invention. The charging system 100 includes at least one mobile power supply 110, a charging seat 120 and a control device 130.

Preferably, a plurality of the mobile power supplies 110 is provided as to meet the needs of multiple users. The models, capacities and colors, etc., of the mobile power supplies can be same or different to make it diversify, so as to meet users' personalized and diversified needs.

The charging seat 120 serves as the main body of the charging system for fixing the mobile power supplies 110 and setting the control device 130. Specifically, the charging seat 120 can be designed as a cabinet, which shape may be square, spherical, cylindrical as well as other irregular shape. It can be understood that, in order to adapt to the surrounding environment, the charging seat 120 can be designed as other shape. The charging seat 120 includes a plurality of charging units 122 for fixing and charging the mobile power supplies 110. The number of the charging units 122 is equal to the number of the mobile power supplies 110. The charging unit 122 includes a fixing device 1222 and a charging device 1224. The fixing device 1222 is configured to fix the mobile power supply 110. The fixing device 1222 have two states of lock and unlock. When the fixing device 1222 is in the unlocked state, users can get the mobile power supply 110 from the charging unit 122 to charge the electronic devices they carry with themselves. After the mobile power supply 110 is removed the fixing device 1222 remains the status of unlocked until a mobile power supply 110 is placed in the charging unit 122. The fixing device 1222 switches from the unlocked state to the locked state when it is detected that a mobile power supply 110 is placed in the charging unit 122, so as to facilitate the return of the mobile power supply 110 by the user and ensure that the user returns after use of the mobile power supply 110. The fixing device 1222 can be a locking structure, and correspondingly, a groove/slot/notch corresponding to the locking structure can be formed on the mobile power supply 110. The fixing device 1222 can also be a magnetic device, and correspondingly, a metal structure corresponding to the magnetic device can be formed on the mobile power supply 110. The metal structure may be disposed inside the mobile power supply 110, or may be composed of a part of or all of the metal shell of the mobile power supply 110. The magnetic device in the fixing device 1222 may be disposed inside the charging seat 120, or may be an attraction bracket on the surface of the charging seat 120.

The charging device 1224 is used for charging the mobile power supply 110 that is fixed in the charging unit 122. The charging device 1224 includes a circuit for charging and a circuit for output. The circuit for charging is used for managing the charging of the mobile power supply 110, and the circuit for output is used for outputting a charging current which has a target voltage to the mobile power supply 110. The circuit for charging is disposed inside the charging unit 122 so as to protect the circuit for charging from being accidently damaged. The circuit for output includes output terminals and peripheral circuits. In an embodiment, the output terminals of the circuit for charging of the charging device 1224 are magnetic. The magnetic output terminals are disposed in the surface of the charging unit 122 facing the mobile power supply 110. Therefore, a metal contact is formed in the mobile power supply 110 at a position corresponding to the magnetic output terminal. For example, when the bottom of the mobile power supply 110 contacts the charging unit 122, the metal contact is disposed in the bottom of the mobile power supply 110. The metal contacts are used to form an electrical connection with the magnetic output terminal so as to charge the mobile power supply 110, so that only the output interface needs to be provided on the mobile power supply 110 without providing the charging input interface. In other embodiments, the circuit for output of the charging device 1224 may also use USB output interface, and accordingly, a matching USB interface needs to be set on the mobile power supply 110 to achieve the electrical connection between the charging device 1224 and the mobile power supply 110. In an alternative embodiment, the circuit for output can also charge the mobile power supply 110 by using a wireless output method. Therefore, the circuit for output comprises a wireless transmitting circuit including a transmitting coil and is disposed inside the charging unit 122 in the same manner as the circuit for charging. Accordingly, a wireless circuit for receiving including a wireless coil for receiving needs to be provided inside the mobile power supply 110. Therefore, when the mobile power supply 110 is fixed in the charging unit 122, the charging device supplies power to the mobile power supply 110 through a wireless charging manner, so as to implement wireless charging. Preferably, the charging device 1224 can also perform wireless charging for mobile devices that has the operation permission and has the wireless charging function.

The control device 130 is disposed in the charging seat 120 and electrically connected to the charging unit 122. Specifically, the control device 130 is used to manage and control the charging system 100. The control device 130 is configured to receive users' charging request, and generate an unlocking command according to the charging request of the users. The unlocking command is used to control the fixing device 1222 to change into an unlocked state, that is, to unlock the fixing device 1222 so that the user can remove the mobile power supply 110 from the charging unit 122. After the user gets the mobile power supply 110, the user can use the mobile power supply 110 to charge the electronic devices carried by itself. During the charging process, the user can carry the portable power supply 110 with him/her without having to place the electronic device such as a mobile phone at a designated location for charging. Thus the charging process is convenient and safe. In this embodiment, the charging seat 120 further includes an input device. The input device is used for users to input a charging request which includes user's information. User's information includes user's name, user's password and payment account and other information. Upon receiving the charging request, the control device 130 determines whether the user has the operation right to borrow the mobile power supply according to the received user' information. In this embodiment, to obtain the operation permission, the user needs to register, authenticate or deliver the deposit first. When a user registers, the user needs to provide the user's name, password, payment account and so on, The control device 130 stores the user's information when the user is registered. When the registered user uses the system again, the user name and password can be used for authentication. The control device 130 compares the received user's information with the stored user's information. If the received user's information is consistent with the stored user's information and the payment account is available, it indicates that the user has an operation right. Users can also not register, but deliver the deposit directly. When the control device 130 receives the deposit, the control device 130 automatically generates a temporary account for the user and grants the temporary account operation permission.

The control device 130 is disposed in the charging seat 120 and electrically connected to the charging unit 122. Specifically, the control device 130 is used to manage and control the charging system 100. The control device 130 is configured to receive users' charging request, and generate an unlocking command according to the charging request of the users. The unlocking command is used to control the fixing device 1222 to change into an unlocked state, that is, to unlock the fixing device 1222 so that the user can remove the mobile power supply 110 from the charging unit 122. After the user gets the mobile power supply 110, the user can use the mobile power supply 110 to charge the electronic devices carried by itself. During the charging process, the user can carry the portable power supply 110 with him/her without having to place the electronic device such as a mobile phone at a designated location for charging. Thus the charging process is convenient and safe. In this embodiment, the charging seat 120 further includes an input device. The input device is used for users to input a charging request which includes user's information. User's information includes user's name, user's password and payment account and other information. Upon receiving the charging request, the control device 130 determines whether the user has the operation right to borrow the mobile power supply according to the received user' information. In this embodiment, to obtain the operation permission, the user needs to register, authenticate or deliver the deposit first. When a user registers, the user needs to provide the user's name, password, payment account and so on. The control device 130 stores the user's information when the user is registered. When the registered user uses the system again, the user name and password can be used for authentication. The control device 130 compares the received user's information with the stored user's information. If the received user's information is consistent with the stored user's information and the payment account is available, it indicates that the user has an operation right. Users can also not register, but deliver the deposit directly. When the control device 130 receives the deposit, the control device 130 automatically generates a temporary account for the user and grants the temporary account operation permission.

Preferably, the unlock command generated by the control device 130 can directly control all the fixing devices 1222 at which the mobile power supply 110 is fixed to change into unlock states. So that the user can choose the mobile power supply 110 according to his or her preference. When the control device 130 detects that the mobile power supply 110 is removed from the charging unit 122, the control device 130 control the other fixing devices 1222 to get back to the locked state. In an embodiment, the unlock command generated by the control device 130 may also directly control predetermined fixing devices 1222 to change into the unlocked state, so that the user can only use the designated mobile power supply 110. In this embodiment, the designated mobile power supply 110 is a mobile power supply capable of satisfying the power consumption of the user. That is, the users' charging request also includes requirement of the electricity quantity. The control device 130 generates an unlock command according to the electricity demand. And the unlock command is used to unlock the fixing devices 1222 where the target mobile power supplies (the mobile power supplies 110 satisfying the electricity demand) is located.

In an embodiment, the input device in the charging seat 120 is further used for inputting the demand for unlocking. There may be a plurality of devices for inputting, which are correspondingly disposed around the charging unit 122. In this embodiment, the unlock demand generated by the control device 130 does not directly control the fixing devices 1222, but is outputted to the user. The demand for unlocking includes the information of the target mobile power supply 110, and the information includes code or location. After receiving the demand for unlocking, the user reaches where the target mobile power supply 110 locates, and inputs the demand for unlocking via the input device and then get the target mobile power supply. In this embodiment, the demand for unlocking may be a password, a barcode, a two-dimensional code, or the like. The input device may be keyboard for inputting a password, a screen for touching or a code scanning device for scanning a barcode or a two-dimensional code. For example, when the user obtains the identity verification through the control device 130 and ensures that the payment account is available (i.e., when the chargeback may be made or the balance satisfies the usage requirement), the user obtains the operation permission and the control device 130 automatically allocates a mobile power supply 110 of sufficient power and sends s the information of the mobile power supply 110 and the generated unlock command (a password or two-dimensional code) to the user. After the user ensures the position of the mobile power supply 110 and the fixing device 1222 according to the information of the mobile power supply 110, the user inputs a password or provide a two-dimensional code according to the voice or the display of the input device. The control device 130 confirms the information of the user according to the password or the two-dimensional code, and performs comparison and verification again. After the authentication is passed, the control device 130 unlocks the corresponding fixing device 1222 and records the information of the mobile power supply 110 and the information of the user to form a usage record. In this embodiment, after the control device 130 unlocks the fixing device 1222, the control device 130 prompts the user to remove the mobile power supply 110 through voice and display.

In an embodiment, the information of user further includes the usage status for recording whether the user is using the mobile power supply 110. The usage status include in-use status and unused status. After the user removed the mobile power supply 110, the control device 130 records the information of the mobile power supply 110 and the information of the user to form the usage record, and switch the usage status to the in-use status. The control device 130 further acquires the information about the mobile power supply 110 when it is detected that the mobile power supply 110 is placed in the charging unit 122 and obtains the information of the user from the usage record according to the information about the mobile power supply 110 and switches the usage status to the unused status. When the control device 130 detects that the usage status switches from in-use status to unused status, the control device 130 deducts the fee from the payment account. If the user directly delivers the deposit, the control device 130 deducts the current usage fee from the temporary account and returns the balance to the user and deletes the record of the temporary account in time.

In this embodiment, the control device 130 is further configured to monitor the running status and the power status of the mobile power supply 110 on the charging seat 120 in real time so as to manage charging of each mobile power supply 110. When it is detected that the power of the mobile power supply 110 is lower than a present value, the control device 130 control the circuit for charging to charge the mobile power supply 110. When it is detected that the power of the mobile power supply 110 is higher than a present value, the control device 130 control the charging circuit to stop charging of the mobile power supply 110.

The above-mentioned charging system provides a plurality of mobile power supplies 110, thus it can meet the charging request of a plurality of users. There is no need to place an electronic device to be charged such as a mobile phone at a designated location for charging. Thus the charging process is convenient and safe.

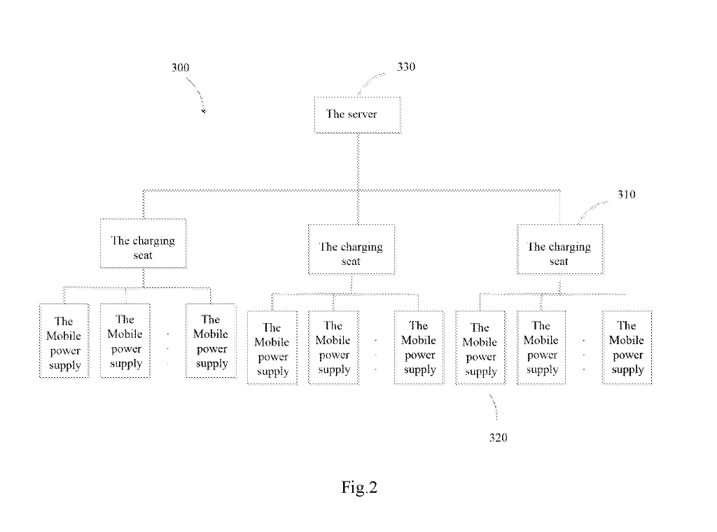

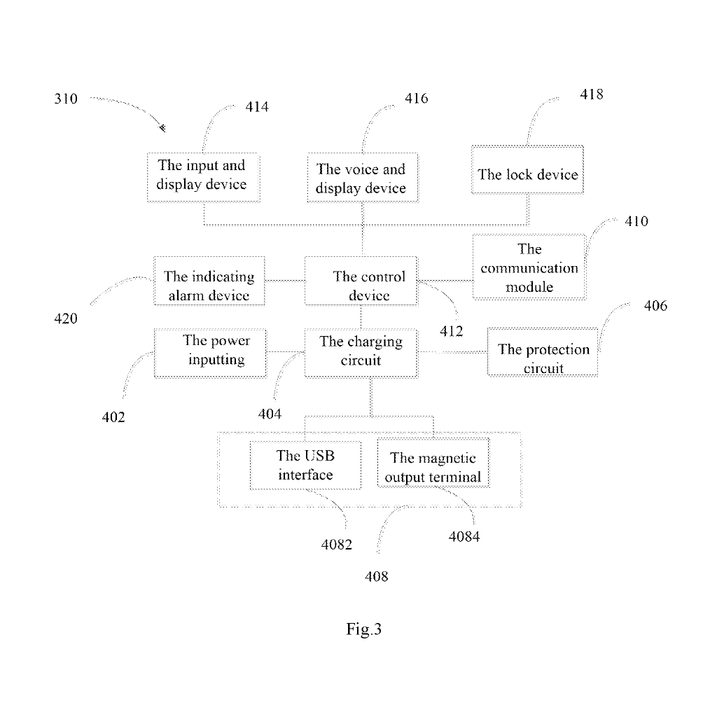

FIG. 2 is a block diagram of a charging system 300 in accordance with another embodiment. The charging system 300 includes charging seat 310, mobile power supplies 110 and a server 330. The charging seat 310 is communicatively connected to the server 330. The charging seat 310 may be multiple, and a plurality of charging seats 310 are disposed in different regions. The block diagram of the charging seat 310 is shown in FIG. 3. In this embodiment, the charging seat 310 includes an interface for power inputting 402, a circuit for charging 404, a protection circuit 406, a port for charging output 408, a communication module 410, a control device 412, an input display device 414, a voice broadcast device 416 a locking device 418, and an indicating alarm device 420.

The charging seat 310 uses an alternating current (AC) adapter. The interface for power inputting 402 is connected to the AC adapter and the circuit for charging 404. The AC adapter converts AC voltage to DC voltage for use of the charging seat 310. In an embodiment, a backup power supply is further disposed in the charging seat 310 to charge the mobile power supply 110 when the external power supply is cut off. The circuit for charging 404, the circuit for protecting 406 and the port for charging output 408 together form a charging device. The port for charging output 408 includes the USB interface 4082 and magnetic output terminal 4084. The magnetic output terminal 4084 is used to electrically connect with the metal contacts in the mobile power supply 110 to charge the mobile power supply 110. The USB interface 4082 is used to connect with the external electronic device to charge the external electronic device. The communication module 410 is used to communicate with the server 330. The charging seat 310 and the server 330 may be connected wirelessly or wiredly. The input device in the input and display device 414 is used by the user to input information data such as the power request, the user's information, and the unlock command. The display device in the input and display device 414 can display the information input by the user and provide a query interface for querying the power status of each of the mobile power supply 320 in the charging seat 310. In this embodiment, the input and display device 414 is a touch display panel. The voice playing device 416 can set the content to be played, and broadcasts the set voice information in the predetermined steps and scenes. The locking device 418 is used as a fixing device for fixing the mobile power supply 320. The mobile power supply 320 is provided with a locking portion that cooperates with the locking device 418 to achieve the locking and unlocking functions as required. The control device 412 is used for alarming when an abnormal situation (such as abnormal performance of the mobile power supply 320, forced removal of the mobile power supply 320, etc.) is monitored to improve the safety of the equipment. Moreover, the indication alarm device 420 can also instruct the locking device 418 in an unlocked state to facilitate the user to access the mobile power supply 320. In an embodiment, the indication alarm device 420 may also indicate the charging status (whether charging) of the mobile power supply 320 and the power level, so as to facilitate intuitive understanding of the status of the mobile power supply 320. The alarm device 420 includes an indicator light, and the state of the locking device 418, the state of charge of the mobile power supply 320, and the power amount are indicated by the on/off state of the indicator light. In an embodiment, the indicator light can be set as a colored light with a beautiful appearance, so that both the electricity quantity and status indication can be realized and the appearance of the charging seat 310 can also be improved.

In an embodiment, the charging seat 310 further includes a mounting device and a moving device. The mounting device is configured to fix the charging seat 310 at a specific position, and the moving device is configured to move the charging seat 310 to any places as needed. It can be understood that an authorized person (usually an administrator) is able to operate the moving device. The server 330 is communicatively connected to the charging seat 310 in order to obtain the power status and the running status of the mobile power supply 320 for overall monitoring and management. After receiving the registration request from the user, the control device 312 in the charging seat 310 further sends the registered user's information to the server 330. Therefore, when there are users in the charging seat 310 that need to perform identity authentication, the user's information may be looked up from the server 330 and verified, so as to ensure that the user can use the same user's information on different charging seat 310 to perform corresponding operations and improve the ease of use of the process. In other embodiments, when receiving the registration request from the user, the control device 412 may directly send the request to the server 330, and the server 330 may verify and store the registration information. The control device 412 also sends the formed usage record to the server 330 so that the user can conveniently return the mobile power supply 320 on different charging seat 310.

The above charging system can provide users with mobile power supplies to charge electronic devices, the charging process is convenient and safe. The above charging system is especially suitable for public places where the flow of people is large and the people will stay for a certain period of time.

Each feature in the above embodiment can combine, and in order to make the description simple, all possible combinations of the features in the above embodiments are not described. However, as long as there is no conflict between the features of the embodiments, the combinations should be considered as the scope of this manual.

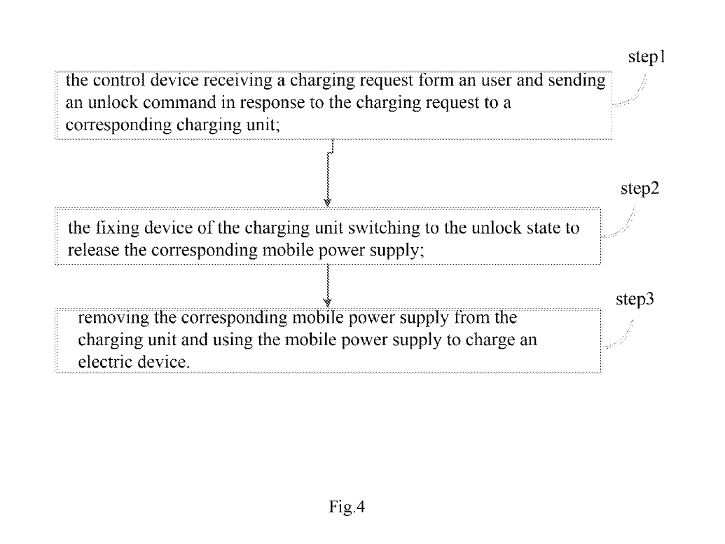

Please refer to the FIG. 4, FIG. 4 illustrate a embodiment of the charging method, and it include step 1, step 2 and step.

The above-mentioned embodiments merely present several embodiments of the invention, which are described in detail, but should not be interpreted as limiting the scope of the invention. It should be noted that those skilled in the art may make various modifications and improvements without departing from the concept of the invention, all of which fall within the protection scope of the invention. Therefore, the protection scope of the present patent shall be subject to the appended claims.

1. A charging system, comprising a plurality of mobile power supplies, a plurality of charging units and a control device;
wherein each of the plurality of charging units comprises a fixing device and a charging device, the fixing device is changeable between a locked state where one of the plurality of mobile power supplies is locked in the charging unit by the fixing device and an unlocked state where said one of the plurality of the mobile power supplies is unlocked from the charging unit, and the charging device is configured to charge said one of the mobile power supplies fixed in the charging unit; and
the control device is connected to the plurality of charging units, the control device is configured to receive a charging request from a user and generate an unlock command in response to the charging request to control the fixing device to switch to the unlocked state so that the user can take said one of the plurality of the mobile power supplies away from the charging unit.

2. The charging system of claim 1, wherein the charging request comprises user's information, and the control device is further configured to determine whether the user has an operation permission according to the user's information and generate the unlock command when the user has the operation permission.

3. The charging system of claim 2, wherein the user's information comprises a usage status, wherein the usage status comprises an in-use status and an unused status;
the control device is further configured to record information of the mobile power supply and the user's information to generate a usage record, and switch the usage status to the in-use status after a remove of said one of the plurality of the mobile power supplies from the charging unit is detected; and
the control device is further configured to obtain the user's information from the usage record according to the information of the mobile power supply and switch the usage status to the unused status after a condition where said one of the mobile power supplies is put into the charging unit is detected.

4. The charging system of claim 3, wherein the user's information further comprises information of a payment account, and the control device is further configured to deduct from the payment account when the usage status in the user's information is switched from the in-use status to the unused status.

5. The charging system of claim 1, wherein the charging system further comprises a charging seat, the plurality of mobile power supplies, the plurality of charging units and the control device are disposed on the charging seat; and
the charging seat further comprises an input device configured for the user to input the unlock command.

6. The charging system of claim 5, wherein the input device is a keyboard or a touch screen for inputting a password, or a code scanning device for scanning a bar code and a two-dimensional code.

7. The charging system of claim 5, wherein the charging device comprises a charging circuit and an output circuit , the charging circuit is disposed inside the charging seat, the output circuit is configured to perform a wired or wireless connection with one of plurality of the mobile power supplies fixed on the corresponding charging unit; and
the control device is further configured to monitor a power of the mobile power supply fixed on the charging unit in real time and control the charging process according to the power.

8. The charging system of claim 1, wherein the control device is further configured to output the unlock command to the fixing device with the mobile power supply, and the control device is further configured to control the fixing device fixed with the mobile power supply to switch to the locked state after the remove of the mobile power supply from the charging unit is detected.

9. The charging system of claim 1, the charging request further comprises power amount data, the control device is further configured to generate the unlock command after a target mobile power supply is matched according to the power amount data, and the unlock command is used to unlock the fixing device where the target mobile power supply is located.

10. The charging system of claim 1, wherein the system further comprises an indication alarm module , and the control device is further configured to generate an alarm signal when a condition where the fixing device is in the locked state but the mobile power supply is removed is monitored; the indication alarm module is configured to send an alarm according to the alarm signal, and the indication alarm module is further configured to instruct that the fixing device is in the unlocked state.

11. The charging system of claim 1, wherein the system further comprises a server, the server is connected to the control device and the server is configured to monitor a power status and a running status of the mobile power supplies in real time.

12. The charging system of claim 5, wherein the fixing device comprises a magnetic device disposed inside the charge seat, and a metal structure corresponding to the magnetic device is arranged on the mobile power supply.

13. The charging system of claim 1, the charging device comprises a magnetic output terminal, and a movable power supply provided with a metal contact adapted to the magnetic output terminal.

14. The charging system of claim 1, the charging device comprises a USB output interface, and a USB interface adapted to the USB output interface is provided on the mobile power supply.

15. A charging method using the charging system of claim 1, comprising:
receiving a charging request from an user by the control device;
sending an unlock command in response to the charging request to a corresponding charging unit by the control device;
switching the fixing device of the charging unit to the unlock state to release a corresponding mobile power supply;
removing the corresponding mobile power supply from the charging unit; and
using the mobile power supply to charge an electric device.

16. The charging method of claim 15, wherein the charging method further comprises:
returning the corresponding mobile power supply back to the corresponding charging unit;
controlling the fixing device of the corresponding charging unit to fix the corresponding mobile power supply by the control device; and
controlling the charging device of the corresponding charging unit to charge the corresponding mobile power supply by the control device.

17. The charging method of claim 15, wherein the charging request comprises user's information and the charging method further comprises:
judging whether the user has an operation permission according to the user's information by the control device; and
generating the unlock command when the user has an operation permission by the control device.

18. The charging method of claim 17, wherein the user's information comprises a usage status including an in-use status and an unused status, and the charging method further comprises:
recording the information of the corresponding mobile power supply and the user's information to generate a usage record by the control device; and
switching the usage status to the in-use status when a remove of the corresponding mobile power supply from the corresponding charging unit is detected.

19. The charging method of claim 18, wherein the charging method further comprises:
obtaining the user's information from the usage record according to the information of the mobile power supply by the control device; and
switching the usage status to the unused status when a condition where the corresponding mobile power supply is put into the corresponding charging unit is detected.

20. The charging method of claim 15, wherein the charging method further comprises:
sending the unlocked command to the fixing device fixed with corresponding mobile power supply by the control device, and
controlling the fixing device fixed with the corresponding mobile power supply to switch to the lock state by the control device, after a remove of the corresponding mobile power supply from the corresponding charging unit is detected.
